(19) United States
(12) Patent Application Publication
(10) Pub. No.: US 2009/0013801 A1
(43) Pub. Date: Jan. 15, 2009

(54) Physical quantity sensor element

(75) Inventors: Shuichi Yamashita, Kariya-city (JP); Masashi Totokawa, Nagoya-city (JP); Masao Naitou, Nagoya-city (JP); Tetsuo Imamura, Toyoake-city (JP); Kenji Morikawa, Hekinan-city (JP); Takuji Iwano, Hiratsuka-city (JP)

Correspondence Address: HARNESS, DICKEY & PIERCE, P.L.C., P.O. BOX 828, BLOOMFIELD HILLS, MI, 48303, US

(73) Assignees: DENSO CORPORATION, Kariya-city (JP); Tanaka Kikinzoku Kogyo K.K., Tokyo (JP)

(21) Appl. No.: 12/217,899

(22) Filed: Jul. 9, 2008

(30) Foreign Application Priority Data
Jul. 13, 2007 (JP) 2007-184680

(51) Int. Cl. G01L 1/22

(52) U.S. Cl. 73/862.045

(57) ABSTRACT

A physical quantity sensor element includes a strain sensitive resistor and an electrically insulating material. The strain sensitive resistor has an electrical resistance value changeable in response to a change of a strain level generated by application of a stress. The electrically insulating material is bonded to the strain sensitive resistor, the electrically insulating material having an electrically insulating property. The strain sensitive resistor includes (a) a matrix including a glass and (b) electrically conductive particles that are dispersed in the glass. The glass is free of lead and includes bismuth.

### CROSS REFERENCE TO RELATED APPLICATION

This application is based on and incorporates herein by reference Japanese Patent Application No. 2007-184680 filed on Jul. 13, 2007.

### BACKGROUND OF THE INVENTION

1. Field of the Invention:

The present invention relates to a physical quantity sensor element that measures a physical change amount, such as a force, a pressure, a torque, a speed, an acceleration, an impact force, a weight/mass, a degree of vacuum, a turning force, a vibration, and a noise.

2. Description of Related Art:

Conventionally, an assembly having a strain sensitive resistor is disclosed as a physical quantity sensor element, which measures an physical change amount or a change in a physical quantity, such as a force, a pressure, a torque, a speed, an acceleration, an impact force, a weight/mass, a degree of vacuum, a turning force, a vibration, and a noise. The above assembly is practically used, and the strain sensitive resistor has a strain sensitive property, in which an electrical resistance value changes in accordance with a change of a strain level. The strain sensitive resistor is known to a matrix having a glass and electrically conductive particles dispersed in the glass (for example, see JP-A-2005-172793 corresponding to U.S. Pat. No. 7,059,203, JP-A-2003-247898, JP-A-2005-189106 corresponding to U.S. Pat. No. 7,224,257).

However, conventionally, a glass matrix that forms the strain sensitive resistor disadvantageously includes a lead, which is one of the environmentally hazardous substances that may provide adverse influence to an environment, in order to obtain a preferable strain sensitive property. Also, there is a limitation on a particle diameter of the electrically conductive particles disadvantageously.

### SUMMARY OF THE INVENTION

The present invention is made in view of the above disadvantages. Thus, it is an objective of the present invention to address at least one of the above disadvantages.

To achieve the objective of the present invention, there is provided a physical quantity sensor element that includes a strain sensitive resistor and an electrically insulating material. The strain sensitive resistor has an electrical resistance value changeable in response to a change of a strain level generated by application of a stress. The electrically insulating material is bonded to the strain sensitive resistor, the electrically insulating material having an electrically insulating property. The strain sensitive resistor includes (a) a matrix including a glass and (b) electrically conductive particles that are dispersed in the glass. The glass is free of lead and includes bismuth.

### BRIEF DESCRIPTION OF THE DRAWINGS

The invention, together with additional objectives, features and advantages thereof, will be best understood from the following description, the appended claims and the accompanying drawings in which:

FIG. 1 is a cross-sectional view illustrating a schematic structure of a physical quantity sensor element according to one embodiment of the present invention;

FIG. 2 is a chart illustrating a relation between a bismuth oxide content and a resistance change rate in response to application of a load of 300 MPa according to a glass matrix of a strain sensitive resistor; and

FIG. 3 is a chart illustrating the resistance change rate in response to application of a load of 300 MPa based on a change of a particle diameter of electrically conductive particles.

### DETAILED DESCRIPTION OF PREFERRED EMBODIMENTS

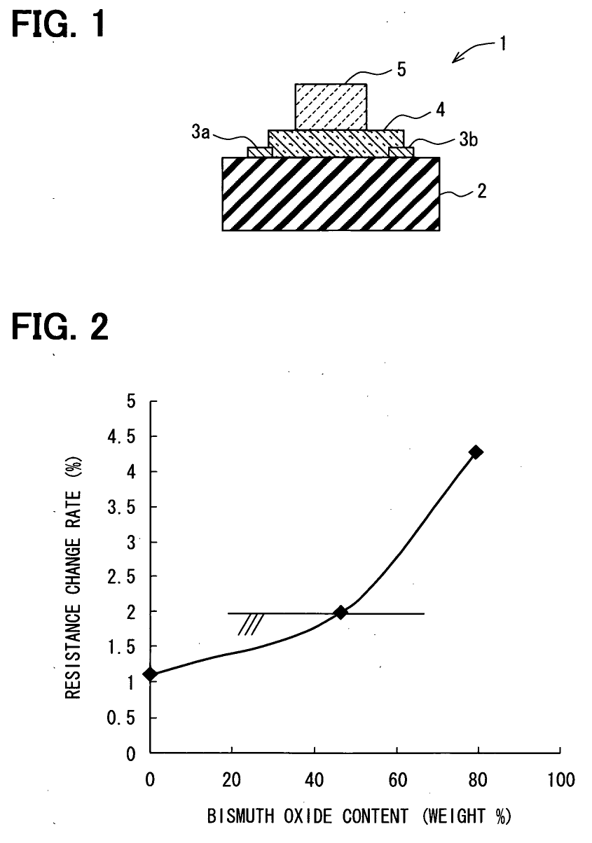

A physical quantity sensor element according to one embodiment of the present invention is described with reference to accompanying drawings. FIG. 1 is a cross-sectional view illustrating a schematic structure of a physical quantity sensor element 1 according to the one embodiment of the present invention.

The physical quantity sensor element 1 includes a substrate 2, a pair of electrodes 3a, 3b, a strain sensitive resistor 4, and a pressure sensing part 5. The pair of electrodes 3a, 3b are provided on the substrate 2 separately from each other. The strain sensitive resistor 4 is formed on the substrate 2 to connect between the electrodes 3a, 3b. The pressure sensing part 5 is fused on the strain sensitive resistor 4.

The substrate 2 is an electrically insulating plate material, and includes a ceramic plate of alumina (Al2O3), for example. It should be noted that the substrate 2 serves as an electrically insulating material having an electrically insulating property.

The electrodes 3a, 3b are formed by, for example, applying silver pastes as electrically conductive materials on the surface of the substrate 2, and by performing a heat treatment.

The strain sensitive resistor 4 has an electrical resistance value changeable in response to a change of a strain level that changes based on the applied stress. For example, the resistor 4 has a structure, in which electrically conductive particles are dispersed in a glass matrix. It should be noted that the glass matrix includes bismuth but does not include lead. For example, the strain sensitive resistor 4 is made by using a paste material that is a mixture of (a) a glass frit including bismuth and (b) ruthenium oxide (RuO2) particles serving as the electrically conductive particles. In the above, the glass frit has an average particle diameter of about 1 μm. Also, the ruthenium oxide particles have a particle diameter ranging from 20 to 1000 nm and may have an average particle diameter of 100 nm and an area/weight ratio of 15 m2/g. The above paste material is screen-printed on a surface of the substrate 2, and is sintered or fired at a temperature equal to or higher than a melting point of the glass frit to form the strain sensitive resistor 4.

The pressure sensing part 5 is configured to receive a load F that is applied from an exterior, and is made of a plate material having an electrically insulating property similar to the substrate 2. For example, the pressure sensing part 5 is made of a ceramic plate of alumina (Al2O3), and is fixed the surface of the strain sensitive resistor 4 by fusion.

Next, the strain sensitive resistor 4 is detailed. For example, a glass used for the strain sensitive resistor 4 may be a borosilicate glass, which does not includes lead or is free of lead, and which includes bismuth instead. In the above case, the borosilicate glass has a bismuth oxide (Bi2O3) content of equal to or greater than 46 weight % and of less than 80 weight %, for example.

An example of a glass composition is shown below. Bi2O3: 46 to 79 weight %, SiO2: 1 to 8 weight %, B2O3: 8 to 16 weight %, Al2O3: 1 to 10 weight %, CaO: 1 to 2 weight %, ZnO: 6 to 7 weight %, ZrO2: 0 to 12 weight %, remainders: MgO, BaO, TiO2, Na2O, K2O, Fe2O3, CuO, SO2, HfO2. Also, the strain sensitive resistor 4 has a ruthenium oxide content of 20 to 30 weight %.

FIG. 2 is a chart illustrating a relation between (a) a bismuth oxide content and (b) a resistance change rate that corresponds to an applied load of 300 MPa according to the glass matrix that constitutes the strain sensitive resistor 4. It is noted that the strain sensitive resistor 4 has a thickness of about 10 μm. As shown in the chart in FIG. 2, in a state, where the glass does not include the bismuth oxide, the resistance change rate indicates about 1.2%. When the bismuth oxide content is increased, the resistance change rate is increased accordingly. For example, when the bismuth oxide content indicates 46 weight %, the resistance change rate reaches 2%.

The strain sensitive resistor 4 is able to constitute the physical quantity sensor element 1 that is capable of measuring a physical change amount without using a special detection circuit if the strain sensitive resistor 4 has the resistance change rate of equal to or greater than 2%. When the bismuth oxide content is further increased, the resistance change rate is further increased accordingly. When the bismuth oxide content indicates 80 weight %, the resistance change rate reaches 4.5%. It should be noted if the glass matrix has the bismuth oxide content of equal to or greater than 80 weight %, the above glass matrix is not preferable in consideration of reliably achieving a form and a strength of the glass matrix.

Note that, a firing temperature for firing mixture of the glass frit and the ruthenium oxide particles is about 850° C. when the bismuth oxide content in the glass is 46 weight %, and the firing temperature is about 600° C. when the bismuth oxide content is 80 weight %.

When the above physical quantity sensor element 1 receives with the load F that is applied to the pressure sensing part 5 from an exterior, the electrical resistance value of the strain sensitive resistor 4 changes in response to the change of the strain level, and the change of the resistance value is detected via the pair of electrodes 3a, 3b to measure the physical change amount.

As is apparent from the above, the physical quantity sensor element 1 of the present embodiment includes the strain sensitive resistor 4 and the substrate 2 that are bonded with each other. The strain sensitive resistor 4 has an electrical resistance value changeable in response to change of the strain level due to the application of stress. The substrate 2 serves as an electrically insulating material that has an electrically insulating property. The strain sensitive resistor 4 includes the electrically conductive particles that are dispersed in a glass matrix or in a matrix of glass, which does not includes lead, and which includes bismuth. Thus, the electrical resistance value changes in accordance with the change of the strain level (strain amount) generated by the application of stress, and thereby the physical change amount is enabled to be measured based on the detection of the change of the resistance value. Also, because the glass, which forms the strain sensitive resistor 4, does not include lead that is one of the environmentally hazardous substances, the adverse influence to the environment is limited even in a case, where the glass is disposed.

Specifically, because the electrically conductive particles include the ruthenium oxide, the strain sensitive resistor 4 is able to be formed in the above simple manufacturing process, in which the paste material is screen-printed on the substrate 2 and is sintered. It is noted that the above paste material includes the mixture of (a) the glass frit including bismuth but not including lead and (b) the electrically conductive particles including ruthenium oxide. Also, the electrical resistivity of the resistor material made of the glass and the ruthenium oxide is widely adjustable by changing the amount of ruthenium oxide. Thus, the strain sensitive resistor 4 of any desired resistance value is obtainable.

Also, because the glass has the bismuth oxide content of equal to or greater than 46 weight %, the strain sensitive resistor 4 gives a strain sensitive property that is practically sufficient. For example, the practically sufficient strain sensitive property may correspond to a resistance change rate of equal to or greater than 2% in a condition where stress of 300 MPa is applied. Thus, there is provided the physical quantity sensor element 1 that is capable of measuring the physical change amount without using a special detection circuit. Specifically, because the glass has the bismuth oxide of less than 80 weight %, the strain sensitive resistor 4 maintains a required strength and still provides the strain sensitive property that is sufficient in practical use.

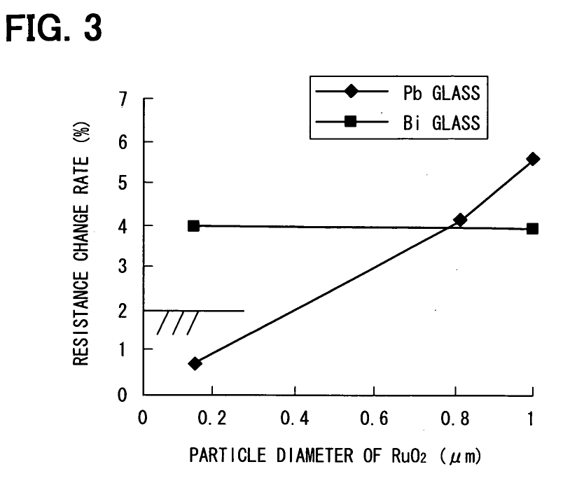

Further, as shown in FIG. 3, in a case, where the glass containing Bi of the present embodiment of the present invention is used, the strain sensitivity can be maintained even in a case where the particle diameter of the electrically conductive particles is reduced. As above, the glass of the present embodiment is different from the conventional glass containing Pb.

It should be noted that, the present invention is not limited to the above described embodiments. However, various modification may be made to the present invention without departing from the spirit and scope thereof.

For example, in the above embodiment, the substrate 2 employs a plate material of alumina. However, the substrate 2 is not limited to the above. Also, the above embodiment describes ruthenium oxide, which serves as the electrically conductive particles that are dispersed in the glass matrix constituting the strain sensitive resistor 4. However, other electrically conductive material other than the ruthenium oxide may be alternatively used.

The present invention is applicable, for example, when a strain sensitive resistor of a physical quantity sensor element is needed to be made free of lead.

Additional advantages and modifications will readily occur to those skilled in the art. The invention in its broader terms is therefore not limited to the specific details, representative apparatus, and illustrative examples shown and described.

What is claimed is:

1. A physical quantity sensor element comprising:
a strain sensitive resistor that has an electrical resistance value changeable in response to a change of a strain level generated by application of a stress; and
an electrically insulating material that is bonded to the strain sensitive resistor, the electrically insulating material having an electrically insulating property, wherein:
the strain sensitive resistor includes (a) a matrix including a glass and (b) electrically conductive particles that are dispersed in the glass, the glass being free of lead and including bismuth.

2. The physical quantity sensor element according to claim 1, wherein the electrically conductive particles include ruthenium oxide.

3. The physical quantity sensor element according to claim 1, wherein the glass has a bismuth oxide content of equal to or greater than 46 weight %.

4. The physical quantity sensor element according to claim 3, wherein the glass has the bismuth oxide content of less than 80 weight %.

5. The physical quantity sensor element according to claim 2, wherein the glass has a bismuth oxide content of equal to or greater than 46 weight %.

6. The physical quantity sensor element according to claim 5, wherein the glass has the bismuth oxide content of less than 80 weight %.
